(19) United States
(12) Patent Application Publication
(10) Pub. No.: US 2004/0123751 A1
(43) Pub. Date: Jul. 1, 2004

(54) Multi-purpose printer device

(76) Inventor: Ramon Vega, Sabadell (ES)

Correspondence Address: HEWLETT-PACKARD COMPANY, Intellectual Property Administration, P.O. Box 272400, Fort Collins, CO, 80527-2400, US

(21) Appl. No.: 10/737,681

(22) Filed: Dec. 16, 2003

Related U.S. Application Data
(63) Continuation-in-part of application No. 09/902,722, filed on Jul. 12, 2001.

(51) Int. Cl. B41L 13/00

(52) U.S. Cl. 101/114; 101/129

(57) ABSTRACT

A computer readable storage medium having embedded thereon one or more computer programs is described. The one or more computer programs are configured to effectuate printing onto a medium and include a set of instructions configured to cause a printer to apply a material onto a mesh-like substrate having a plurality of holes to form a pattern, filling at least a portion of the holes with the material and expel a fluid from a nozzle at a substantially high rate of speed toward the material held within the hole, wherein the fluid is configured to contact the material and cause the material to be substantially forced out of the hole and applied onto the medium.

### RELATED APPLICATION DATA

This application is a continuation-in-part of U.S. patent application Ser. No. 09/902,722, entitled “Multi Purpose Printer Device” and naming Ramon Vega as inventor, which was filed on Jul. 12, 2001 and published as U.S. patent application No. 20030010231 A1 on Jan. 16, 2003 and which is hereby incorporated herein by reference.

### FIELD OF THE INVENTION

This invention relates generally to printer devices. More specifically, the invention relates to printer devices that utilize a nozzle operable to expel a fluid onto a mesh-like substrate containing a material, in which the expelled fluid is operable to punch the material through the mesh-like substrate, such that the material may be applied onto a medium.

### BACKGROUND OF THE INVENTION

It is generally known that inkjet printers utilize at least one printhead possessing a plurality of nozzles through which ink drops are fired onto a medium, e.g., fabric, paper, etc., to create an image on the medium, e.g., plot, drawing, etc. According to one type of inkjet printer, ink is typically supplied substantially continuously over a plurality of resistors generally located beneath the openings of the nozzles. In use, certain of the resistors are activated, i.e., heated, to vaporize a portion of the ink on the resistors, thereby causing a portion of the ink to be fired through the respective nozzle openings. According to another type of inkjet printer, ink is typically supplied substantially continuously over a plurality of piezoelectric elements located beneath the openings of the nozzles. In this type of printer, certain of the piezoelectric elements are caused to deform at a relatively rapid rate, thereby causing ink positioned thereover to be fired through the respective nozzle openings.

Although conventional inkjet printers are widely used and have been found to be substantially suitable for their intended purposes, they are not completely immune from certain drawbacks and disadvantages. For example, to generally maintain the printheads in relatively proper operating condition, e.g., to prevent ink from drying in the nozzles, the printheads routinely undergo servicing operations, e.g., cleaning, spitting, capping, etc. At least by virtue of the potential for ink drying in the nozzles, conventional ink-jet printers may be unable to utilize relatively faster drying inks. In addition, chemicals utilized in certain inks to increase their performance (e.g., inks having solid materials to relatively reduce some of the deleterious effects of sunlight) may be incompatible with the printhead materials. In this respect, conventional inkjet printers are relatively limited to the types of inks that may be utilized in printing onto a medium.

Generally speaking, a disadvantage associated with conventional printers is that they are often limited to printing on flat media. That is, the medium used in conventional printers are often supplied in rolls and are unrolled over a print area of the printers in a substantially flat configuration. In this respect, conventional printers are typically unable to print on non-flat surfaces, i.e., rough, round, irregularly shaped, etc.

### SUMMARY OF THE INVENTION

According to one aspect, the present invention pertains to a device for printing onto a medium. The device includes a mesh-like substrate having a hole, in which the hole is configured to hold a material for application onto the medium. The device also includes a nozzle for expelling a fluid, in which the nozzle is maneuverable substantially directly over the at least one hole. In addition, the nozzle is operable to expel the fluid onto the material held in the hole to thereby cause the material to be applied onto the medium and thereby print an image on the medium.

According to another aspect, the present invention relates to a method for printing onto a medium. In the method, a material is applied onto a mesh-like substrate having hole and a portion of the hole is filled with the material. In addition, a fluid is expelled from a nozzle at a substantially high rate of speed toward the material held within the hole. Moreover, the fluid is configured to contact the material and cause the material to be substantially forced out of the hole and applied onto the medium.

According to yet another aspect, the present invention relates to a computer readable storage medium on which is embedded one or more computer programs, in which the one or more computer programs may implement a method for printing onto a medium. The one or more computer programs include a set of instructions for applying a material onto a mesh-like substrate having hole and filling a portion of the hole with the material. Furthermore, expelling a fluid from a nozzle at a substantially high rate of speed toward the material held within the hole, such that the fluid is configured to contact the material and cause the material to be substantially forced out of the hole and applied onto the medium.

Accordingly, certain embodiments of the present invention are capable of achieving certain advantages, including, the capability of applying various types of materials that are typically incompatible with conventional printheads onto a medium and of applying materials onto media having non-flat surfaces.

### BRIEF DESCRIPTION OF THE DRAWINGS

Features and advantages of the present invention will become apparent to those skilled in the art from the following description with reference to the drawings, in which:

FIG. 1 illustrates a diagrammatic plan view of a printer device in accordance with the principles of the present invention;

FIG. 2 illustrates an enlarged cross-sectional view taken along lines II-II of FIG. 1;

FIG. 3 illustrates a front plan view of a printer device according to one embodiment of the present invention;

FIG. 4 illustrates a top view of a printer device according to another embodiment of the present invention;

FIG. 5 is a diagrammatic plan view of an embodiment of the present invention;

FIG. 6 illustrates an exemplary block diagram of a printer device in accordance with the principles of the present invention; and

FIG. 7 illustrates an exemplary flow diagram of a manner in which the principles of the present invention may be practiced.

### DETAILED DESCRIPTION OF THE INVENTION

For simplicity and illustrative purposes, the principles of the present invention are described by referring mainly to an exemplary embodiment thereof, particularly with references to an example of a printer device having a single mesh-like substrate and a single nozzle. However, one of ordinary skill in the art would readily recognize that the same principles are equally applicable to, and can be implemented in, any printer device that utilizes any reasonably suitable number of substrates and nozzles, and that any such variation would be within such modifications that do not depart from the true spirit and scope of the present invention.

According to the principles of the present invention, a device and method for application of materials onto a medium is disclosed. For example, in accordance with the principles of the present invention, the device includes a mesh-like substrate configured to hold the material within a plurality of holes. The device also includes a nozzle configured to expel fluid at a relatively high rate of speed at the material held within the holes to thereby force the material out of the holes. At least by virtue of the fact that the material does not make contact with the nozzle, any number of different types of materials maybe utilized, e.g., those materials that may be incompatible with the nozzle. In this respect, for example, a solid material (e.g., powder) may also be printed onto the medium. Additionally, the materials applied onto the medium may be mixed during the application process. Moreover, operation of the device is not limited to media having flat surfaces.

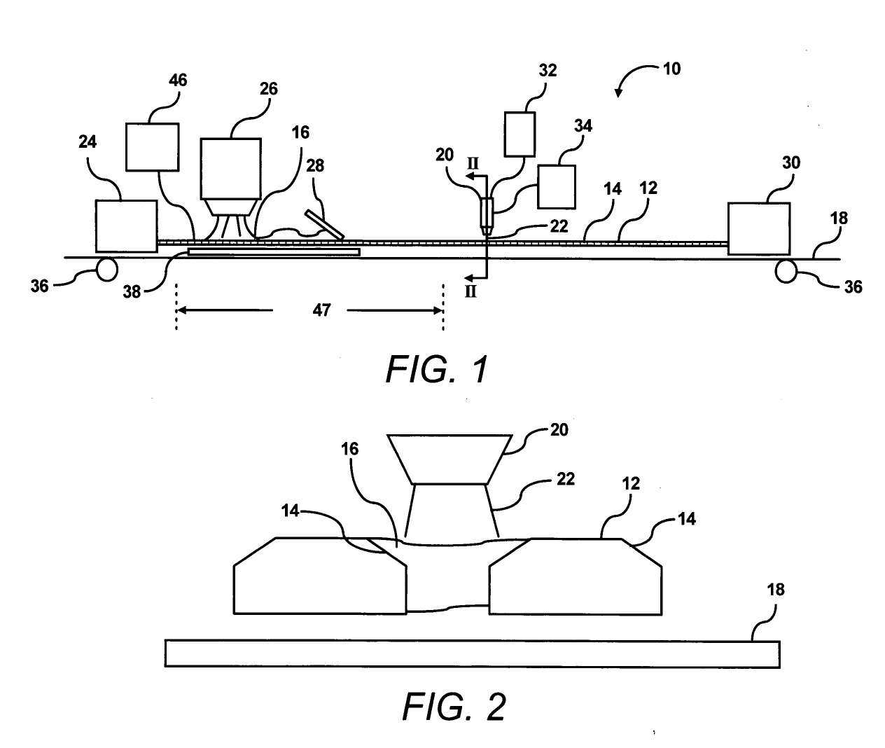

FIG. 1 illustrates a diagrammatic plan view of a printer device 10 in accordance with the principles of the present invention. The printer device 10 is shown as including a mesh-like substrate 12 having a plurality of holes 14 for holding a material 16 (shown in FIG. 2). The printer device 10 is also shown as including a nozzle 20 configured to expel fluid 22 toward the material 16 held within the holes 14. Although only one nozzle 20 is illustrated in FIG. 1, it is within the purview of the present invention that any reasonably suitable number of nozzles maybe implemented in the printer device 10 without deviating from the scope or spirit of the present invention. Accordingly, a plurality of nozzles 20 may be utilized substantially simultaneously or to expel fluid 22 toward the material 16 held within a plurality of holes 14.

The nozzle 20 may be connected to a nozzle mechanism 32 that is operable to maneuver the nozzle 20 in at least two directions. The nozzle mechanism 32 may include any reasonably suitable mechanism operable to maneuver the nozzle 20 into controlled positions. For example, the nozzle mechanism 32 may include a belt and pulley system, a track mechanism, etc. The nozzle mechanism 32 may also include any reasonably suitable force producing device to provide the necessary force to expel the fluid 22 at a substantially high rate of speed. For example, the nozzle 20 maybe part of a conventional inkjet printhead and the fluid 22 may be a known ink.

In addition, the nozzle 20 may be connected to a pressurized air source and the fluid 22 may be air. The nozzle 20 may also be connected to a fluid source 34 operable to supply the fluid 22 into the nozzle. The fluid source 34 may be any reasonably suitable type of fluid supply, including, for example, a reservoir, refillable tank, replaceable tank, and the like. In addition, the fluid source 34 may include any reasonably suitable number of fluid sources that may contain any reasonably suitable number of various fluids, such that various fluids may be expelled through a single nozzle 20 and/or a plurality of nozzles.

The medium 18 may be maneuvered by a medium moving mechanism 36. The medium moving mechanism 36 may be configured to manipulate the medium 18 into various positions with respect to the mesh-like substrate 12 and the nozzle 20. In this respect, as the fluid 22 and material 16 are applied onto a portion of the medium 18, the medium may be advanced such that another application of fluid and material may be applied on another portion of the medium. Although FIG. 1 illustrates the medium 18 as being composed of a generally flat sheet, it is within the purview of the present invention that the medium may constitute substantially any reasonably suitable shape. For example, the medium 18 may comprise an irregular shape, non-flat surfaces, etc.

In use, the fluid 22 may be ejected from the nozzle 20 at a substantially high rate of speed and may be configured to contact the material 16 with sufficient force to cause the material 16 to be forced out of the hole 14, in a direction substantially toward the medium 18. When the fluid 22 makes contact with the material 16, the fluid and the material may be configured to substantially mix together, i.e., formulated to be substantially chemically intermixed to thereby form a composition, at some time after the fluid contacts the material, e.g., during the initial contact, during travel to the medium, on the medium, etc.

The printer device 10 may also include a supply bin 26 for storing material 16 to be supplied onto the mesh-like substrate 12 and a collecting bin 38 for collecting excess material. Although only one supply bin 26 is illustrated in FIG. 1, it is within the purview of the present invention that a plurality of supply bins may be included in the printer device 10, with each of the supply bins being capable of supplying a variety of materials, e.g., various colors, compositions, etc. In addition, by implementation of a plurality of supply bins containing, for example, a plurality of differently colored substances, the substances may be applied on the mesh-like substrate 12 in substantially the manner in which they are to be applied onto the medium, to facilitate the application of the substances on the medium. In this respect, it would be unnecessary to move the mesh-like substrate 12 to re-apply substances onto the mesh-like substrate at various times or when substantially all of the substances have been applied on the mesh-like substrate. Moreover, a plurality of various mesh-like substrates may be utilized to hold various substances, such that the mesh-like substrates may each be positioned in a position to substantially enable the nozzle 20 to expel predetermined ones of the substances.

The printer device 10 is also illustrated as including a substrate moving mechanism 24 for moving the mesh-like substrate 12. The substrate moving mechanism 24 may be configured to maneuver the mesh-like substrate 12 such that certain portions thereof are first placed under the supply bin 26 to receive a supply of material 16. The printer device 10 may also include a scraper 28 to scrape off any excess material 16 from the mesh-like substrate 12 and to substantially ensure that a controlled amount of material is inserted into the holes 14. In this respect, the scraper 28 may be positioned at a location substantially between the supply bin 26 and the nozzle 20. In addition, the substrate moving mechanism 24 may be configured to maneuver the mesh-like substrate 12 such that certain of those portions that have received the material 16 are placed under the nozzle 20.

According to the principles of the present invention, the material 16 may comprise a solid, liquid, or a solid/liquid mixture. If the material 16 is a liquid, the material may be poured from the supply bin 26 substantially over the holes 14 of the mesh-like substrate 12. In this respect, the density of the material 16 may be configured to prevent a substantial portion of the material from falling through the holes 14 during the pouring operation. In addition, the diameter of the holes 14 may also be configured to substantially prevent the material 16 from falling therethrough. In one respect, the density of the material 16 and the diameter of the holes 14 may be optimized to ensure that the material 16 is held within the holes and that the material may be expelled from the holes by operation of the nozzle 20.

The holes 14 and the material 16 may be configured such that the material may be held within the holes by action of capillary forces. In addition, the material 16 may include charged particles and the mesh-like substrate 12 may be connected to a power source 39 for supplying electricity to the mesh-like substrate. In this regard, the material 16 may be held in the holes 14 by operation of electrostatic or electromagnetic forces. In one respect, the material 16 may comprise a chemical composition that may be incompatible or harmful to the components of the nozzle 20. For example, the material 16 may comprise a drying agent that may be activated by interaction with a fluid 22 expelled from the nozzle.

If the material 16 is a solid, the material is preferably in powder form, with the material being composed of particles that are relatively smaller than the diameter of the holes 14. In one respect, the material 16 may comprise a chemical composition that may be incapable of expulsion from the nozzle 20. For example, the material 16 may comprise a powder (e.g., containing a pigment that substantially prevents color fading) that may be activated by interaction with a fluid 22 expelled from the nozzle 20.

The printer device 10 may also include a cleaning mechanism 30 located downstream of the nozzle 20. The cleaning mechanism 30 may include any reasonably suitable component configuration to substantially remove any un-applied material 16 from the mesh-like substrate 12. For example, the cleaning mechanism 30 may include a fluid source located beneath the mesh-like substrate 12 configured to expel fluid through the mesh-like substrate. In this respect, the cleaning mechanism 30 may also include a vacuum device configured to collect the fluid and material expelled in this manner from the mesh-like substrate 12. As another example, the cleaning mechanism 30 may include a device for wiping off substantially any un-applied material 16 from the mesh-like substrate 12. In this respect, the cleaning mechanism 30 may include the application of a cleaning fluid, e.g., water, cleaning agent, etc., onto the mesh-like substrate 12 along with a collecting device operable to collect the cleaning fluid and the expelled material.

The printer device 10 may operate to position the nozzle 20, mesh-like substrate 12, and the medium 18 at various positions with respect to each other to thereby apply the material 16 onto specific areas of the medium. According to one embodiment of the present invention, the mesh-like substrate 12 and the medium 18 may be maneuvered into various positions with respect to each other and the nozzle 20 by operation of the substrate mechanism 24 and the medium moving mechanism 36. According to another embodiment, the nozzle 20 may be maneuvered into various positions with respect to the mesh-like substrate 12 and the medium 18 by operation of the nozzle mechanism 32. In addition, the mesh-like substrate 12, medium 18, and nozzle 20 may all be movable with respect to each other to provide a greater range of material 16 placement accuracy.

FIG. 2 illustrates an enlarged cross-sectional view taken along line II-II of FIG. 1. In FIG. 2, the nozzle 20 is illustrated as being substantially positioned over the material 16 located within the hole 14 of the mesh-like substrate 12. When the fluid 22 is expelled from the nozzle 20, the fluid is caused to contact the material 16 at a substantially high rate of speed. The force of the collision between the fluid 22 and the material 16 may cause the material to be ejected from the hole 14 and applied onto the medium 18. By positioning the nozzle 20 over a variety of holes, the material 16 may be applied on the material at predetermined positions to thereby create an image thereon.

According to a preferred embodiment of the present invention, a portion of the hole 14 is shown as shaped as an inverted cone. In one respect, the inverted cone shape facilitates the insertion of the material 16 into the hole 14. It is, however, within the purview of the present invention that the hole 14 may be shaped in any reasonably suitable manner without deviating from the scope and spirit of the present invention.

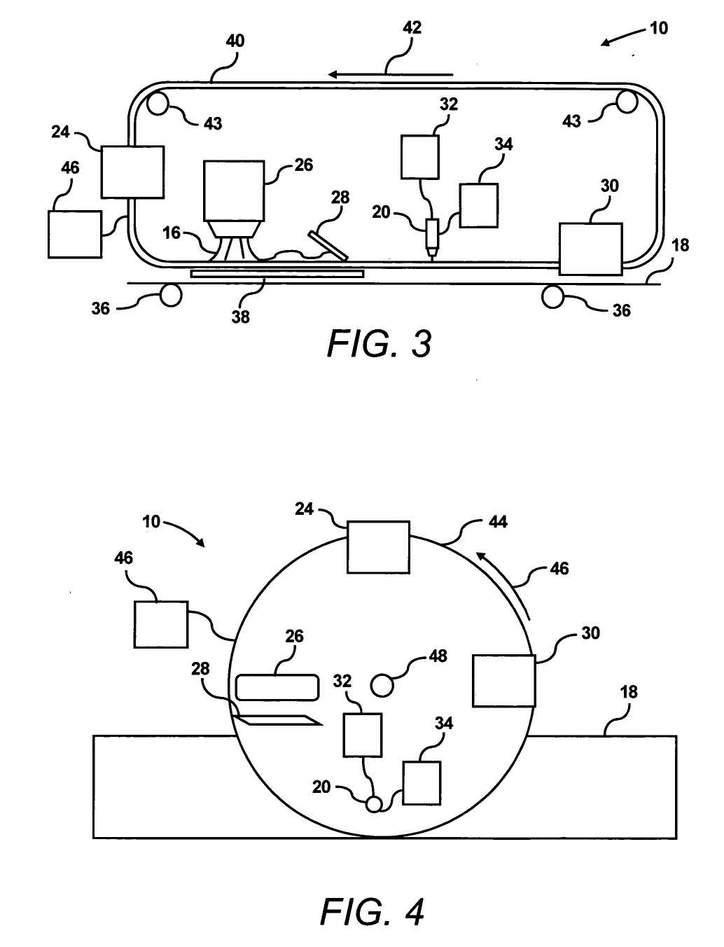

FIG. 3 illustrates a front plan view of a printer device 10 according to one embodiment of the present invention. In this embodiment, the mesh-like substrate 40 is shaped as a continuous loop, such that a printing operation may substantially be continuously performed. During a printing operation, the material 16 may be applied on the mesh-like substrate 40 from the supply bin 26, with substantially any excess material being removed by the scraper 28. A portion of the mesh-like substrate 40 containing the material 16 may be maneuvered under the nozzle 20 such that by operation of the nozzle, fluid 22 may be expelled onto the material 16 and the material may be deposited onto the medium 18. Substantially any un-deposited material 16 may be removed by the cleaning mechanism 30 as the mesh-like substrate 40 travels in a direction 42. For example, the mesh-like substrate may be guided on rollers 43, only two of which are shown in FIG. 3 for simplicity of illustration and ease of understanding. Another batch of material 16 may be supplied to the cleaned portion of the mesh-like substrate 40 and the material deposition process may be repeated in a substantially continuous manner. In addition, the material 16 may include charged or magnetic particles and the mesh-like substrate 40 may be connected to a power source 39 for supplying electricity or magnetism to the mesh-like substrate. In this regard, the material 16 may be held in the holes 14 by operation of electrostatic or electromagnetic forces.

FIG. 4 illustrates a top view of a printer device 10 according to another embodiment of the present invention. In this embodiment, the mesh-like substrate 44 may be disc-shaped or have the shape of a flattened toroid with a central opening 47 and may rotate about an axis 48, such that a printing operation may substantially be continuously performed. During a printing operation, the material 16 may be applied on the mesh-like substrate 44 from the supply bin 26, with substantially any excess material being removed by the scraper 28. A portion of the mesh-like substrate 44 containing the material 16 may be maneuvered under the nozzle 20 such that by operation of the nozzle, fluid 22 may be expelled onto the material 16 and the material 16 may be deposited onto the medium 18. Any un-deposited material 16 may be removed by the cleaning mechanism 30 as the mesh-like substrate 44 travels in a direction 46. Another batch of material 16 may be applied onto the cleaned portion of the mesh-like substrate 44 and the material deposition process may be repeated in a substantially continuous manner.

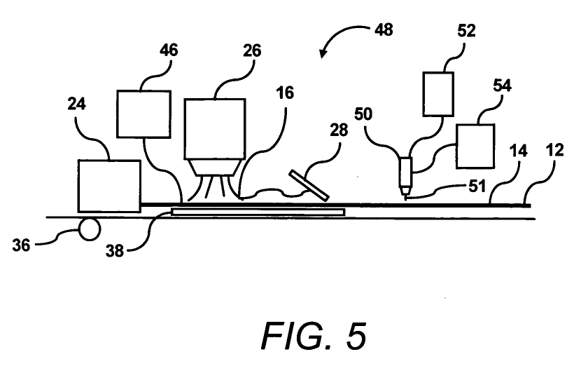

FIG. 5 is a diagrammatic plan view of a portion 49 corresponding to an embodiment of the present invention. The portion 49 may correspond to the portion 47 shown in FIG. 1 or an analogous portion of the embodiments shown with respect to FIGS. 2 and/or 3. The portion 49 shows a printhead 50 dispensing printing medium 51 according to positioning via mechanism 52 from print medium reservoir 54.

In one embodiment, the supply bin 24 may or may not be included and one or more printheads 50 moveable under the influence of mechanism 52 analogous to mechanism 32 of FIG. 1 may be employed to print a pattern of print medium 51 from print medium reservoir 54 on the mesh-like substrate 12 of FIGS. 1 and 2, 40 of FIG. 3 or 44 of FIG. 4. In one embodiment, the nozzle 20 (FIG. 1, not shown in FIG. 5) blows continuously across the width of the mesh-like substrate 12 to transfer the pattern to the medium 18. In one embodiment, the supply bin 24 is eliminated and the printhead 50 transfers a pattern of print medium 51 directly onto the mesh-like medium.

Advantages afforded by such a configuration include allowing the fluid 16 to dry prior to transfer to the medium, reducing exposure of the medium 18 to liquids. In one embodiment, the power source 39 may also heat the mesh-like substrate 12 or 40. In one embodiment, the nozzle 20 employs a high pressure to force the pattern of print medium from the mesh-like substrate 12 onto the print medium 18.

In one embodiment, the supply bin 24 of any of FIGS. 1 and 3-5 and ancillary apparatus operated to dispense the material 16, which may be adherent to the mesh-like substrate. In one embodiment, adherence is aided via introduction of electrical charge from power source 39 of any of FIGS. 1 and 3-5, magnetic energy from power source 39 or heat from power source 39 and may undergo a phase change or partial melting in response thereto. In one embodiment, the printhead 50 supplies a pattern of print medium 51 that causes the material 16 to be selectively depositable on the print medium 18 via operation of the nozzle 20.

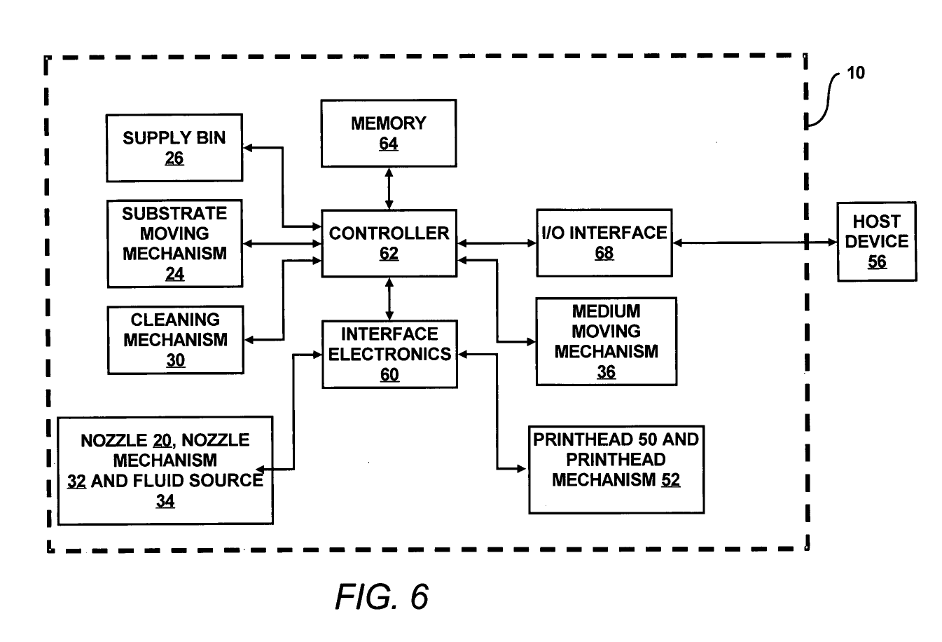

FIG. 6 illustrates an exemplary block diagram of a printer device 10 in accordance with the principles of the present invention. As will become better understood from a reading of present disclosure, the following description of the block diagram depicted in FIG. 6 illustrates one manner in which a printer device 10 may be operated in accordance with the principles of the present invention. In this respect, it is to be understood that the following description of FIG. 6 is but one manner of a variety of different manners in which such a large format inkjet printer may be operated.

Generally speaking, the printer device 10 may include a nozzle 20, although a plurality of nozzles may also be included. The nozzle 20 maybe configured to repeatedly pass across a medium in individual, horizontal swaths or passes during a printing operation to print a particular image (e.g., picture, text, diagrams, etc.) onto the medium. The nozzle 20 may be maneuvered by a nozzle mechanism 32 and supplied with fluid by a fluid source 34. In addition, the mesh-like substrate and the medium may also be moved during the printing operation to thereby facilitate the application of the particular image on the medium. Additionally, the printhead 50 may be maneuvered by the printhead mechanism 52 and supplied with print media by the source 54.

The printer device 10 may also include interface electronics 60. The interface electronics 60 may be configured to provide an interface between a controller 62 of the printer device 10 and the nozzle 20, the fluid source 34, and the nozzle mechanism 32, e.g., a carriage, belt and pulley system, etc.

The controller 62 may be configured to provide control logic for the printer device 10, which provides the functionality for the printer device. In this respect, the controller 62 may possess a microprocessor, a micro-controller, an application specific integrated circuit, and the like. The controller 62 may be interfaced with a memory 64 configured to provide storage of a computer software that provides the functionality of the printer device 10 and may be executed by the controller. The memory 64 may also be configured to provide a temporary storage area for data/file received by the printer device 10 from a host device 66, such as a computer, server, workstation, and the like. The memory 64 may be implemented as a combination of volatile and non-volatile memory, such as dynamic random access memory (“RAM”), EEPROM, flash memory, and the like. It is, however, within the purview of the present invention that the memory 64 may be included in the host device 66.

The controller 62 may be further interfaced with an I/O interface 68 configured to provide a communication channel between the host device 66 and the controller 62. The I/O interface 68 may conform to protocols such as RS-232, parallel, small computer system interface, universal serial bus, etc. In addition, the controller 62 is interfaced with the material supply 26, the substrate moving mechanism 24, the cleaning mechanism 30, and the medium moving mechanism 36. Although not illustrated in FIG. 6, interface electronics may be provided between the controller 62 and the above-enumerated components in a fashion similar to that described hereinabove with respect to the interface electronics 60 provided between the controller and the nozzle 20.

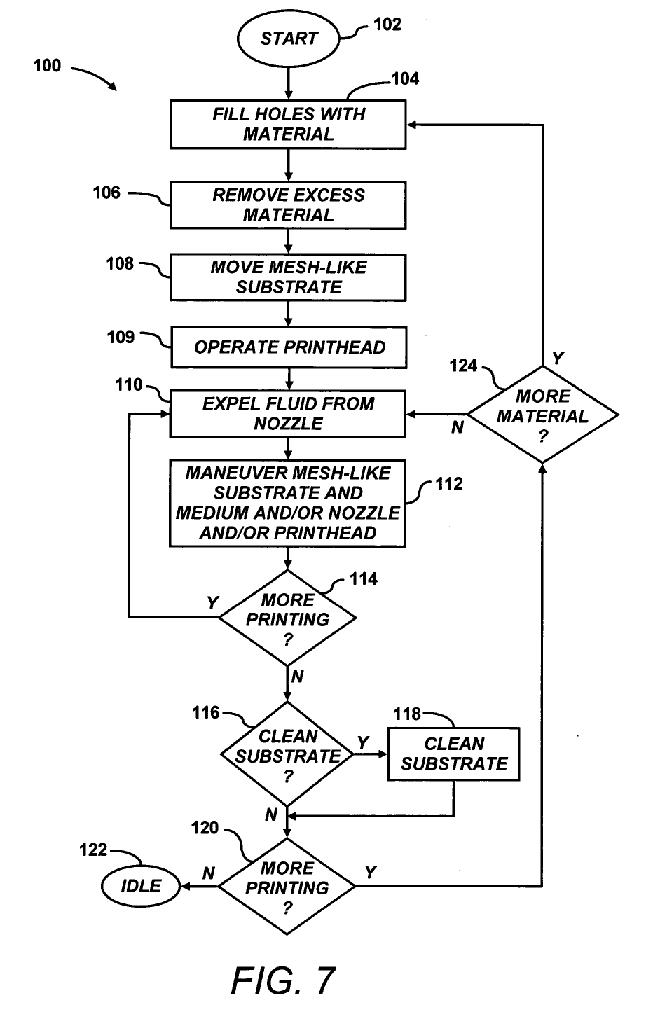

FIG. 7 illustrates an exemplary flow diagram 100 of a manner in which the principles of the present invention may be practiced. The following description of the flow diagram 100 is made with reference to the block diagram illustrated in FIG. 6, and thus makes reference to the elements illustrated therein. It is to be understood that the steps illustrated in the flow diagram 100 may be contained as a subroutine in any desired computer accessible medium or media. Such may include the memory 64, internal and external computer memory units, and other types of computer accessible media, such as a compact disc readable by a storage device. Thus, although particular reference is made in the following description of FIG. 6 to the controller 62 as performing certain functions, it is to be understood that those functions may be performed by any desired computer accessible medium.

In step 102, the printer device 10 may receive instructions to begin a printing operation, i.e., receive a plot file, from the host device 66. At step 104, the controller 62 may control the supply bin 26 to apply material onto the mesh-like substrate to thereby fill at least some of the holes in the mesh-like substrate. The controller 62 may also control the substrate moving mechanism 24 to move the mesh-like substrate in a direction generally towards the nozzle 20.

During travel of the mesh-like substrate, substantially all of the excess material on the mesh-like substrate may be removed as well as the material within the holes may be better seated in the holes by operative of a scraper at step 106.

In addition, by operation of the substrate moving mechanism 24, the portion of the mesh-like substrate containing the material may be maneuvered to a position generally below the nozzle 20 at step 108. When the portion of the mesh-like substrate containing the material is substantially aligned with the nozzle 20, the controller 62 may control the fluid source 34 to supply an amount of fluid into the nozzle as well as to cause the fluid to be expelled through the nozzle at step 110. The expelled fluid may then contact the material located in a hole of the mesh-like substrate with sufficient force to cause the material located therein to be forced out of the hole and in a direction generally toward a medium located therebelow.

At step 112, the controller 62 may control the nozzle mechanism 32 to maneuver the nozzle 20 to another location generally above another hole containing material. In addition to or in place of the above-described step, the controller 62 may cause the substrate moving mechanism 24 and the medium moving mechanism 36 to maneuver the mesh-like substrate and the medium, respectively, into various positions with respect to the nozzle 20. At query task 114, the controller 62 may determine whether an additional print operation is required. In response to the requirement of an additional print operation, step 110 et seq. may be repeated. At query task 116, the process 100 determines when a cleaning operation of the mesh-like substrate is required. For example, when no additional print operations are required or the material supply on the mesh-like substrate is sufficiently low, the controller 62 may determine whether a cleaning operation of the mesh-like substrate is required. The determination of whether a cleaning operation is required may be based upon a plurality of different factors. For example, a cleaning operation may be required when the number of print operations falls below a predetermined threshold level, or when a different material is to be applied on the mesh-like substrate.

If a cleaning operation is required, the controller 62 may operate the substrate moving mechanism to maneuver the mesh-like material through the cleaning mechanism. At step 118, the controller 62 may operate the cleaning mechanism to perform a cleaning operation on the mesh-like material to remove substantially any remaining material on the mesh-like substrate. Once the cleaning operation is complete or if a cleaning operation was not required, the controller 62 may determine whether any additional printing operations are required at query task 120. If no additional printing operations are required, the controller 62 may cause the printer device 10 to go into an idle state at step 122, e.g., stand-by, sleep, etc.

If additional printing operations are required, the controller 62 may determine whether additional material is required to be applied on the mesh-like substrate in query task 124. If additional material is required, the steps enumerated above beginning with step 104 may be repeated. If no additional material is required, the steps enumerated above beginning with step 110 may be repeated.

According to the principles of the present invention, certain aspects of the printer device 10 are capable of achieving certain beneficial results. For example, the printer device 10 maybe capable of printing onto a medium with an ink compound that is mixed together until after the compound is applied on the medium. In one respect, this capability enables the use of ink materials that may not be compatible with other components of the printer device 10. In another respect, this capability enables the use of inks having faster drying times than is currently available as well as the use of solid particles in the inks which may also provide additional beneficial results. Additionally, the medium is not limited to one that is flat or may be fed through a printer. Instead, the printer of the present invention may be utilized to print onto non-flat surfaces (e.g., bars, curved surfaces, spheres, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A device for printing onto a medium comprising:
a heated mesh-like substrate having a plurality of holes configured to hold a material for application onto the medium; and
a nozzle for expelling a fluid, the nozzle being maneuverable substantially directly over the hole, the nozzle being configured to expel the fluid onto the material held in the hole to cause the material to be applied onto the medium and thereby print an image on the medium.

2. The device of claim 1, wherein the substrate comprises a disc.

3. The device of claim 1, wherein the substrate comprises a substantially disc-shaped configuration having a central opening.

4. The device of claim 1, wherein the material is applied to the substrate in a pattern and the nozzle is configured to cause the pattern to be transferred to the medium.

5. The device of claim 1, further comprising a scraper for removing excess material from the mesh-like substrate.

6. The device of claim 1, wherein the fluid comprises a liquid or a gas.

7. The device of claim 1, wherein the material comprises a liquid or a solid substance.

8. The device of claim 1, wherein the hole comprises a generally conical configuration.

9. The device of claim 1, further comprising a power source connected to the mesh-like substrate to supply electricity to the mesh-like substrate, whereby the material may be held within the hole by a charged attraction between the mesh-like substrate and the material.

10. The device of claim 1, further comprising a power source connected to the mesh-like substrate to magnetically charge the mesh-like substrate, whereby the material may be held within the hole by a magnetically charged attraction between the substrate and the material.

11. The device of claim 1, wherein the material is a fluid and is configured to be held within the hole by capillary forces.

12. A method for printing onto a medium comprising:
applying a material onto a mesh-like substrate having a hole, filling a portion of the hole with the material;
heating the substrate;
and expelling a fluid from a nozzle at a substantially high rate of speed toward the material held within the hole, wherein the fluid is configured to contact the material and cause the material to be substantially forced out of the hole and applied onto the medium.

13. The method of claim 12, further comprising removing excess material from the hole with a scraper.

14. The method of claim 12, wherein the material applying step comprises depositing the material from a supply bin spaced from the nozzle.

15. The method of claim 12, wherein the material applying step comprises depositing the material from a supply bin spaced from the nozzle, and further comprising moving the mesh-like substrate to a position generally below the nozzle such that a portion of the mesh-like substrate containing the material is in position to have the material forced out of the hole by operation of the nozzle.

16. The method of claim 12, wherein applying the material comprises applying material into a second hole of the mesh-like substrate and further comprising:
maneuvering the mesh-like substrate and the medium in response to an additional material application being required; and
expelling fluid from the nozzle toward the material held within the second hole, wherein the fluid is configured to contact the material and cause the material to be substantially forced out of the second hole and applied onto the medium.

17. The method of claim 12, further comprising cleaning a substantial portion of any remaining material on the mesh-like substrate in response to the mesh-like substrate requiring cleaning.

18. The method of claim 12, further comprising applying additional material on the mesh-like substrate in response to additional application of material onto the medium being required.

19. The method of claim 12, wherein applying material comprises applying material to a plurality of holes in the mesh-like substrate from a printhead to form a pattern of the material on the mesh-like substrate.

20. A method for printing onto a medium comprising:
applying a first material onto a mesh-like substrate having a plurality of holes to fill a portion of the holes with the material;
depositing a second material in a pattern on the mesh-like substrate using a printhead; and
expelling a fluid from a nozzle at a substantially high rate of speed toward the materials held within the holes, wherein the fluid is configured to transfer the pattern onto the medium.

21. The method of claim 20, further comprising removing excess first material from the hole with a scraper.

22. The method of claim 20, wherein applying the first material comprises depositing the first material from a supply bin spaced from the nozzle, and wherein the mesh-like substrate is heated.

23. The method of claim 20, wherein applying the first material comprises depositing the first material from a supply bin spaced from the nozzle, and further comprising moving the mesh-like substrate to a position generally below the nozzle such that a portion of the mesh-like substrate containing the material is in position to force the first and second materials out of the holes by operation of the nozzle.

24. The method of claim 20, wherein applying the first material comprises applying first material into a second hole of the mesh-like substrate and further comprising:
maneuvering the mesh-like substrate and the medium in response to an additional material application being required; and
expelling fluid from the nozzle toward the material held within the second hole, wherein the fluid is configured to contact the first and second materials and to force the first and second materials out of the holes and onto the medium.

25. The method of claim 20, further comprising cleaning a substantial portion of any remaining material on the mesh-like substrate in response to the mesh-like substrate requiring cleaning.

26. The method of claim 20, further comprising applying additional first and second materials on the mesh-like substrate in response to such being required.

27. The method of claim 20, further comprising at least partially drying the first and second materials by heating the mesh-like substrate.

28. A method of printing comprising:
forming a pattern of material on a mesh-like substrate having a plurality of holes; and
expelling a fluid from a nozzle at a substantially high rate of speed toward the material held within the holes, wherein the fluid is configured to transfer the pattern onto the medium.

29. The method of claim 28, further comprising heating the mesh-like substrate.

30. The method of claim 28, wherein forming a pattern of material on the mesh-like substrate comprises filling portions of the holes with the material.

31. The method of claim 28, wherein forming a pattern of material comprises forming a pattern of material on another material filling a plurality of holes in the mesh-like substrate.

32. The method of claim 28, wherein forming a pattern of material comprises reacting the material with another material filling a plurality of holes in the mesh-like substrate.

33. The method of claim 28, wherein forming a pattern of material comprises at least partially dissolving another material filling a plurality of holes in the mesh-like substrate.

34. The method of claim 28, wherein expelling fluid comprises expelling a gas.

35. A computer readable storage medium on which is embedded one or more computer programs, the one or more computer programs being configured to effectuate printing onto a medium, the one or more computer programs comprising a set of instructions configured to cause a printer to:
apply a material onto a mesh-like substrate having a plurality of holes to form a pattern, filling at least a portion of the holes with the material; and
expel a fluid from a nozzle at a substantially high rate of speed toward the material held within the hole, wherein the fluid is configured to contact the material and cause the material to be substantially forced out of the hole and applied onto the medium.

36. The computer readable storage medium of claim 35, the one or more computer programs further comprising a set of instructions configured to cause the printer to move the mesh-like substrate to a position generally below the nozzle such that a portion of the mesh-like substrate containing the material is in position to have the material forced out of the hole.
